(19) United States
(12) Patent Application Publication
(10) Pub. No.: US 2025/0062112 A1
(43) Pub. Date: Feb. 20, 2025

(54) ACQUISITION OF ION MOBILITY-MASS TO CHARGE RATIO DATA

(71) Applicant: Thermo Fisher Scientific (Bremen) GmbH, Bremen (DE)

(72) Inventor: Alexander A. Makarov, Bremen (DE)

(73) Assignee: Thermo Fisher Scientific (Bremen) GmbH, Bremen (DE)

(21) Appl. No.: 18/796,640

(22) Filed: Aug. 7, 2024

(30) Foreign Application Priority Data
Aug. 15, 2023 (GB) 2312459.7

(51) Int. Cl. H01J 49/42; G01N 27/622; H01J 49/40

(52) U.S. Cl. CPC H01J 49/421; G01N 27/622; H01J 49/40

(57) ABSTRACT

An analytical instrument comprises an ion mobility separator, a mass filter downstream of the ion mobility separator, and a mass analyser downstream of the mass filter. The ion mobility separator performs ion mobility separation scans to separate ions according to ion mobility. The mass filter filters the separated ions using an isolation window, and during each scan: (i) scanning a centre mass to charge ratio (m/z) of the isolation window, and (ii) controlling a width Δmz of the isolation window such that ions emerging from the ion mobility separator within an ion mobility arrival time range ΔT are transmitted by the mass filter. The mass analyser performs mass analysis scan(s) during each ion mobility separation scan in which the mass analyser analyses ions transmitted by or derived from ions transmitted by the mass filter, each mass analysis scan having a duration T, and wherein ΔT<T.

### CROSS REFERENCE TO RELATED APPLICATION

This application claims priority from application GB2312459.7, filed Aug. 15, 2023. The entire disclosure of application GB2312459.7 is incorporated herein by reference.

### FIELD OF THE INVENTION

The present invention relates to the field of mass spectrometry, and in particular to mass spectrometry incorporating ion mobility separation.

### BACKGROUND

In modern mass spectrometry, Fourier Transform (FT) and multi-reflection time-of-flight (mrTOF) mass-spectrometers (MS) provide particularly high performance. FT-MS utilises transient acquisitions on timescales of up to hundreds of milliseconds, while mrTOF-MS utilises transients on timescales of up to 1-2 milliseconds. Meanwhile, high resolution ion mobility separator (hrIMS) devices produce arrival time distributions of peptide ions between <1 and a few milliseconds wide.

Owing to this time mismatch, when FT-MS or mrTOF is used as the detector for high resolution ion mobility separation, ion packets of differing ions, which are separated in ion mobility space, can be detected in the same FT-MS or mrTOF spectrum, thus degrading the separation achieved with ion mobility. This problem is compounded when the combination of FT-MS or mrTOF with hrIMS is applied to proteomics or metabolomics workflows, where fast liquid chromatography (LC) is used to reduce the complexity of the sample.

Therefore, there is a need for interfacing of “slow” mass analysers to hrIMS devices without sacrificing the resolution of the hrIMS device nor the throughput and depth of analysis in the high-performing MS. In general, a “slow” mass analyser may be defined as a mass analyser for which the duration of single mass analysis scan is high enough to reduce the time resolution of an ion mobility separator (IMS) or hrIMS.

HrIMS devices are described in, for example, U.S. Pat. Nos. 6,791,078, 7,838,826, 8,507,852, 8,552,366, 8,835,839, 9,552,969, 10,741,375, and GB 2,494,562.

As described, for example, in GB 2,494,562, there are different ways of operating such hrIMS devices with “slow” mass analysers. This is shown schematically in FIG. 1, where the horizontal axis represents ion mass-to-charge ratio (m/z) and the vertical axis represents the time of ion elution from a hrIMS device. The shaded bands illustrate typical distributions of peptide ions with different charge states, from +1 to +4. Generally, a hrIMS scan of duration T_{IMS}^{max} can contain N MS scans (where N can range, for example, from 1 to >100, depending on the hrIMS device and the analyser). As illustrated in FIG. 1, each MS scan can have the same duration T for simplicity.

The most straightforward way to acquire a two-dimensional ion mobility-m/z diagram would be to select a narrow time slice of ions ΔT during each MS scan, and to then detect their panoramic spectrum using the mass analyser. Detection itself may be delayed relatively to this moment, e.g. ions selected during “MS scan 1” of FIG. 1 may be detected during “MS scan 2” or even “MS scan 3”, as known in the art. By scanning the gating time (as shown by the hatched double lines in FIG. 1) relatively to the start of the ion mobility (IM) separation, it is possible to acquire data for the entire 2D diagram in approximately TIΔT steps. Practically, for an FT-MS operating with a T=64 ms cycle and with a required time resolution ΔT=1 ms, this would require L=TIΔT=64 steps. This leads to a >4 sec overall cycle, even if T≥T_{IMS}^{max}, and even slower otherwise, sometimes making it incompatible with LC.

Another approach is to apply multiple gating windows within each MS scan at variable periods, with subsequent deconvolution of the 2D diagram using, for example, a Hadamard transform (Poltash et al. Anal. Chem. 2018, 90, 10472-10478).

A different approach is described in EP 1,271,138 and GB 2,494,562. Here, a quadrupole mass filter after the hrIMS device is scanned in synchronisation with elution of ions from the hrIMS device, so that only ions of certain mobility-m/z ratio pass into the downstream analyser for detection. A fast orthogonal acceleration ToF mass analyser is used for detection, which provides sufficient time resolution to be compatible with ion mobility separation. This so-called “linked scan” approach effectively allows a selected range of ion mobilities to be cut away.

It is believed that there remains scope for improvements to methods of and apparatus for mass spectrometry.

### SUMMARY

A first aspect provides a method of operating an analytical instrument that comprises an ion mobility separator, a mass filter arranged downstream of the ion mobility separator, and a mass analyser arranged downstream of the mass filter, the method comprising:
the ion mobility separator performing a plurality of ion mobility separation scans, wherein in each ion mobility separation scan the ion mobility separator receives ions and separates them according to their ion mobility;
the mass filter filtering separated ions using an isolation window, and during each ion mobility separation scan: (i) scanning a centre mass to charge ratio (m/z) of the isolation window, and (ii) controlling a width Δmz of the isolation window such that during the ion mobility separation scan, ions emerging from the ion mobility separator within an ion mobility arrival time range ΔT are transmitted by the mass filter; and
the mass analyser performing one or more mass analysis scan(s) during each ion mobility separation scan, wherein in each mass analysis scan the mass analyser receives and analyses ions transmitted by the mass filter or ions derived from the ions transmitted by the mass filter, wherein each mass analysis scan has a duration T, and wherein ΔT<T.

Embodiments are directed to methods of operating an analytical instrument such as a mass spectrometer. The instrument may comprise an ion source configured to generate ions from a sample, an ion mobility separator arranged downstream of the ion source and configured to separate received ions according to their ion mobility, a mass filter arranged downstream of the ion mobility separator and configured to filter received ions according to their mass to charge ratio (m/z) (i.e. using an isolation window that has a centre mass to charge ratio (m/z) and a width Δmz), and a mass analyser arranged downstream of the mass filter and configured to mass analyse received ions. The instrument may optionally comprise a fragmentation device arranged downstream of the mass filter and configured to selectively fragment received ions. The inclusion of ion mobility (IM) separation is beneficial as this improves the duty cycle and the sensitivity of the instrument.

In the method, the ion mobility separator performs a plurality of ion mobility separation scans, and during each ion mobility separation scan the mass filter scans the centre mass to charge ratio of its isolation window, optionally such that ions having a particular charge state are transmitted by the mass filter. Furthermore, the width 4mz of the isolation window is controlled such that during each ion mobility separation scan, ions emerging from the ion mobility separator within an ion mobility arrival time range ΔT are transmitted by the mass filter, where ΔT is less than the duration T of a mass analysis scan.

The method is particularly suited to instruments in which the mass analyser is a relatively “slow” mass analyser, i.e. where the mass analyser does not provide sufficient time resolution for compatibility with ion mobility separation. In the method, the time resolution is instead provided by control of the quadrupole mass filter. In effect, in each ion mobility separation scan, ions corresponding to a “strip” of the two-dimensional (2D) ion mobility arrival time-m/z space are analysed, where each strip has an extent ΔT in the ion mobility arrival time dimension equal to the required time resolution.

In some embodiments, by performing multiple such ion mobility separation scans in which ions from adjacent strips of the 2D ion mobility arrival time-m/z space are analysed, ions within regions of interest of the 2D ion mobility arrival time-m/z space can be analysed in a particularly straightforward and efficient manner.

It will be appreciated, therefore, that embodiments provide improved methods of operating an analytical instrument.

The analytical instrument may be a mass spectrometer, e.g. comprising an ion source. Ions may be generated from a sample in the ion source. The ion source may optionally be coupled to a chromatographic separation device such as a liquid chromatography (LC) separation device, such that the sample which is ionised in the ion source comes from the separation device. Thus, the analytical instrument may comprise an ion source arranged upstream of the ion mobility separator, and a chromatographic separation device arranged upstream of the ion source, and the method may comprise: the chromatographic separation device chromatographically separating a sample; and the ion source ionising the chromatographically separated sample to produce ions.

The analytical instrument comprises an ion mobility separator, which may be arranged downstream of the ion source, and configured to perform ion mobility separation scans to separate ions received from the ion source according to their ion mobility. The ion mobility separator may be operable in a cyclical manner, i.e. to repeatedly perform ion mobility separation scans. In each ion mobility separation scan the ion mobility separator may receive ions from the ion source, and e.g. accumulate a packet of ions in an accumulation region. Alternatively, packets of ions may be accumulated in an ion trap upstream of the ion mobility separator. The ion mobility separator may then separate the packet of ions according to the ions' ion mobility, e.g. by passing the packet of ions through an ion mobility separation region. Ions with a higher ion mobility reach the end of the ion mobility separation region (and leave the separator) ahead of ions with a lower ion mobility.

Each ion mobility separation scan may have a duration T_{IMS}. In other words, the ion mobility separator may have a cycle time T_{IMS}. The duration T_{IMS} may include the time required to accumulate a packet of ions together with the time required to separate ions. Alternatively, the duration T_{IMS} may correspond only to the time required to separate ions, where the accumulation of a packet of ions is performed in parallel with the separation of a previously accumulated packet of ions. The duration T_{IMS} may be on the order of hundreds or a few thousands of milliseconds. The duration T_{IMS} may be constant within any given experiment, but may be varied between experiments by suitable control of the instrument.

The analytical instrument comprises a mass filter arranged downstream of the ion mobility separator and configured to receive separated ions from the ion mobility separator. The mass filter can be any suitable mass filter that is operable to filter ions according to their m/z, such as a quadrupole mass filter. Other types of filter, such as a Wien filter or a time-of-flight filter (e.g. as described in U.S. Pat. No. 7,999,223) may also be used. The mass filter may be configured such that received ions having m/z within an m/z isolation window are isolated and onwardly transmitted by the mass filter, while received ions having m/z outside the m/z isolation window are attenuated by the mass filter, e.g. are not onwardly transmitted by the mass filter. The width and/or the centre m/z of the isolation window are controllable (variable), e.g. by suitable control of RF and/or DC voltage(s) applied to the mass filter. Thus, for example, the mass filter may be operable in a transmission mode of operation, whereby most or all ions within a relatively wide m/z isolation window are onwardly transmitted by the mass filter, and a filtering mode of operation, whereby only ions within a relatively narrow m/z isolation window (centred at a desired m/z) are isolated and onwardly transmitted by the mass filter.

The analytical instrument may optionally comprise a fragmentation device arranged downstream of the mass filter and configured to receive ions transmitted by the mass filter. The fragmentation device may be configured to selectively fragment some or all of the received ions, i.e. so as to produce fragment ions. The fragmentation device may be operable in a fragmentation mode of operation, whereby most or all received ions are fragmented so as to produce fragment ions (which may then be onwardly transmitted from the fragmentation device), and a non-fragmentation mode of operation, whereby most or all received ions are onwardly transmitted without being (deliberately) fragmented. It would also be possible for a non-fragmentation mode of operation to be implemented by causing ions to bypass the fragmentation device.

The analytical instrument comprises a mass analyser arranged downstream of the mass filter (and, where present, downstream of the fragmentation device) and configured to perform mass analysis scans to determine the mass to charge ratio (m/z) of received ions. The mass analyser may be operable in a cyclical manner, i.e. to repeatedly perform mass analysis scans. In each mass analysis scan the mass analyser receives ions and mass analyses them. In embodiments, the mass analyser is an ion trap mass analyser, such as an electrostatic orbital trap, and more specifically an Orbitrap™ FT mass analyser. Alternatively, the mass analyser may be a time-of-flight (ToF) mass analyser, such as a multi-reflection time-of-flight (mrTOF) mass analyser.

It would be possible for the instrument to be configured such that ions can be passed to the mass analyser in the form of an ion beam, e.g. without having been accumulated before being passed to the mass analyser. Thus, in embodiments, ions are accumulated directly within the mass analyser. In these embodiments, the number of ions accumulated within the mass analyser may be controlled by controlling an accumulation time (e.g. fill time) of ions into the mass analyser. This in turn may be controlled by operating a gate or lens of the mass analyser and/or a gate or lens within the instrument upstream of the mass analyser (between the ion source and the mass analyser) in an open (transmitting) mode of operation for a desired amount of time (and otherwise operating the gate or lens in a closed (non-transmitting) mode of operation). Examples of such gates can be found, e.g., in GB 2,585,472. Such a gate or gates could be used to attenuate the intensity of incoming ion peaks using pulse-width modulation where the pulse width is significantly shorter than ΔT. This allows an increase in the dynamic range of spectra acquired by the mass analyser.

In particular embodiments, ions are passed to the mass analyser from an ion trap arranged upstream of the mass analyser. Ions may be initially accumulated within the ion trap, and then passed to the mass analyser, e.g. in the form of a packet of ions. The ion trap may be referred to as an injection device for injecting ions into the mass analyser. The ion trap can comprise any suitable ion trap, such as a linear ion trap or a curved linear ion trap (C-trap), e.g. as described WO 2008/081334.

The ion trap may be used to cool the accumulated ions prior to injecting them into the mass analyser. The ion trap may also or instead be used (in an MS2 mode of operation) as the fragmentation device to fragment ions prior to injecting the fragment ions into the mass analyser.

In these embodiments, the number of ions accumulated within the mass analyser may be controlled by controlling an accumulation time (e.g. fill time) of ions into the ion trap. This in turn may be controlled by operating a gate or lens of the ion trap and/or a gate or lens within the instrument upstream of the ion trap (between the ion source and the ion trap) in an open (transmitting) mode of operation for a desired amount of time (and otherwise operating the gate or lens in a closed (non-transmitting) mode of operation).

Each mass analysis scan has a duration T. In other words, the mass analyser has a cycle time T. T may include all overheads linked to operation of the mass analyser. The duration T may include the time required to accumulate a packet of ions (and optionally to cool and/or fragment those ions, and optionally to inject those ions into the mass analyser) together with the time required to mass analyses those ions. Alternatively, the duration T may correspond only to the time required to mass analyse a packet of ions, or only the time required to accumulate a packet of ions (and optionally to cool and/or fragment those ions), where the accumulation of a packet of ions is performed in parallel with the mass analysis of a previously accumulated packet of ions.

In particular embodiments, the mass analysis scan duration Tis less than the ion mobility separation scan duration T_{IMS}, i.e. T<T_{IMS}. In embodiments, the mass analyser is of a type in which the mass analyser scan time T is relatively long, e.g. such that two or more, tens or a few hundreds of mass analysis scans can be performed during each ion mobility separation scan. The duration T may be on the order of a few milliseconds, tens or hundreds of milliseconds. For example, the duration T may be (i)≥1 ms; (ii)≥2 ms; (iii)≥5 ms; (iv)≥10 ms; (v)≥50 ms; or (vi)≥100 ms. The duration T may be constant within any given experiment, but may be varied between experiments by suitable control of the instrument.

The analytical instrument may be operable in at least an MS1 mode of operation in which the instrument performs one or more MS1 mass analysis scans, and in an MS2 mode of operation in which the instrument performs one or more MS2 mass analysis scans.

In each MS1 mass analysis scan, the mass filter is operated in its transmission mode or in its filtering mode with a relatively broad isolation window width (e.g. of the order of hundreds or thousands of Th), and ions are not (intentionally) fragmented, so that a relatively broad m/z range of ions produced by the ion source is received and mass analysed by the mass analyser.

In each MS2 mass analysis scan, the mass filter is operated in its filtering mode with a relatively narrow isolation window width (e.g. of the order of ones or tens of Th) so as to isolate ions, and the isolated ions are fragmented in the fragmentation device, so that a relatively narrow m/z range of ions produced by the ion source is isolated and fragmented, and the resulting fragment ions are received and mass analysed by the mass analyser.

Each MS1 mass analysis scan may have a duration T_{MS1}, and each MS2 mass analysis scan may have a duration T_{MS2}. Typically, T_{MS1}>T_{MS2} because high resolution data is relatively more important for the MS1 scans, while high speed is relatively more important for the MS2 scans (e.g. so that a much larger number of MS2 scans can be acquired per unit time). Where the instrument is operated in a cyclical manner, typically T_{MS2} may be set as some fraction of T_{MS1}, e.g. T_{MS2}/T_{MS1}=1/2, 1/4, 1/8, 1/16, etc.

In the method, the ion mobility separator performs a plurality of ion mobility separation scans, and during each ion mobility separation scan the centre m/z of the mass filter's isolation window is scanned (varied).

In some embodiments, this is done such that ions having a particular charge state are transmitted by the mass filter. That is, in each ion mobility separation scan, ions of a particular charge state may be preferentially transmitted by the mass filter compared to ions of any other charge state. For example, only ions of the particular charge state may be transmitted and/or most or all ions of other charge states may be attenuated by the mass filter.

To do this, the centre m/z of the mass filter's isolation window may be scanned along a curve or a set of curve segments in ion mobility arrival time-m/z space such that ions having the particular charge state are transmitted by the mass filter. The curve or set of curve segments may be defined with respect to a known relationship between ion mobility arrival time and m/z for ions of the particular charge state.

In this regard, it has long been recognised that there is a relationship between ion mobility arrival time and m/z for ions of various different charge states (e.g. singly charged, doubly charged, triply charged, etc.). These relationships take the form of a distinct band in respect of each different charge state. Each band follows a characteristic curve in ion mobility arrival time-m/z space, and has a characteristic (e.g. average) spread Tb in ion mobility arrival time. Thus, the relationship between ion mobility arrival time and m/z for ions having a particular charge can be described by a curve or set of curve segments in ion mobility arrival time-m/z space, together with a characteristic spread Tb of arrival times. Thus, one or more curves or set of curve segments (and one or more characteristic arrival time spreads Tb) may be defined for the sample under analysis, with each curve or set of curve segments (and each characteristic arrival time spread Tb) corresponding to a particular ion charge state.

As is described in more detail in co-pending application U.S. 63/468,170 the entire contents of which is incorporated herein by reference, the one or more curve or set of curve segments (and the one or more characteristic arrival time spreads Tb) may be determined by performing a calibration for the instrument.

During each ion mobility separation scan, the width Δmz of the mass filter's isolation window is controlled such that during each ion mobility separation scan, ions emerging from the ion mobility separator within an ion mobility arrival time range ΔT are transmitted by the mass filter.

In some embodiments, the width Δmz of the mass filter's isolation window, and so the ion mobility arrival time range ΔT, is controlled such that during each ion mobility separation scan ions having (only) the particular charge state are transmitted by the mass filter. To do this, the width Δmz may be configured such that the ion mobility arrival time range ΔT is less than the characteristic (e.g. average) spread Tb of the band corresponding to ions having the particular charge state, i.e. ΔT Tb.

Correspondingly, for a given mobility separation time T and a given sample, Δmz may be significantly smaller than the spread of m/z of analytes of the sample at that time T, i.e. such that each scan selects only a portion of single charge state. Thus, in each ion mobility separation scan, the mass filter is controlled to transmit ions within a “strip” of the two-dimensional (2D) ion mobility arrival time-m/z space, where each strip optionally tracks a particular ion charge state band and has an extent ΔT in the ion mobility arrival time dimension that is less than the average ion mobility arrival time spread Tb of that band.

Furthermore, the width 4mz of the mass filter's isolation window is controlled such that ΔT is less than the duration T of a mass analysis scan, i.e. ΔT<T. In this regard, the method is particularly suited to instruments in which the mass analyser is a relatively “slow” mass analyser, i.e. where the mass analyser does not provide sufficient time resolution for compatibility with ion mobility separation. In the method, the time resolution is instead provided by control of the quadrupole mass filter. In effect, in each ion mobility separation scan, ions corresponding to a “strip” of the two-dimensional (2D) ion mobility arrival time-m/z space are analysed, where each strip has an extent ΔT in the ion mobility arrival time dimension equal to the required time resolution.

In some embodiments, by performing multiple such ion mobility separation scans in which ions from adjacent strips of the 2D ion mobility arrival time-m/z space are analysed, ions within each band of interest of the 2D ion mobility arrival time-m/z space can be analysed in a particularly straightforward and efficient manner.

Thus, in some embodiments, the method comprises performing multiple ion mobility separation scans in respect of a particular ion charge state band, where in each ion mobility separation scan a different strip from that band is analysed.

Thus, the plurality of ion mobility separation scans may comprise at least a first ion mobility separation scan and a second ion mobility separation scan, and the method may comprise:
during the first ion mobility separation scan: scanning the centre mass to charge ratio of the isolation window along a first curve or first set of curve segments in ion mobility arrival time-m/z space such that ions having a first charge state are transmitted by the mass filter; and
during the second ion mobility separation scan: scanning the centre mass to charge ratio of the isolation window along a second different curve or second set of curve segments in the ion mobility arrival time-m/z space such that ions having the same first charge state are transmitted by the mass filter.

More generally, the plurality of ion mobility separation scans may comprise a first set of K ion mobility separation scans, where K is an integer ≥2, and the method may comprise:

during each of the K ion mobility separation scans: scanning the centre mass to charge ratio of the isolation window along a respective curve or set of curve segments in ion mobility arrival time-m/z space such that ions having a first charge state are transmitted by the mass filter.

The plurality of strips in respect of a particular charge state may cover most of all of the band of interest in the 2D ion mobility arrival time-m/z space. The plurality of strips may be adjacent to one another and may cover the band of interest without leaving any gaps. The plurality of strips may be overlapping and/or non-overlapping.

Thus, most or all of the second curve or second set of curve segments may be separated from the first curve or first set of curve segments by a shift in ion mobility arrival time, where the shift in ion mobility arrival time may correspond to (i.e. may be equal to or approximately equal to) the ion mobility arrival time range ΔT. Equally, for each of the K respective curves or sets of curve segments, most or all of the curve or set of curve segments may be separated from an adjacent curve or set of curve segments by a shift in ion mobility arrival time, where the shift in ion mobility arrival time may correspond to (i.e. may be equal to or approximately equal to) the ion mobility arrival time range ΔT.

The second curve or second set of curve segments may have substantially the same shape in the ion mobility arrival time-m/z space as the first curve or first set of curve segments, and/or all of the K curves or sets of curve segments may have substantially the same shape in the ion mobility arrival time-m/z space. The shape or shapes of the curves or curve segments may be configured to correspond to the shape of the charge state band of interest.

In particular embodiments, the product (K×ΔT) (which may be approximately equal to the characteristic (e.g. average) spread Tb of the band of interest) is less than the duration T of each mass analysis scan. As is described further below, this means that the information of interest can be acquired in a particularly efficient manner.

In embodiments, during each ion mobility separation scan the centre m/z of the isolation window is scanned across a m/z range of interest. The m/z range of interest may be the same for different ion mobility separation scans, or may be different in respect of some or each ion mobility separation scan. The or each m/z range of interest may be continuous. Alternatively, the or each m/z range of interest may comprise a set of distinct and separated m/z sub-ranges. Thus, each strip may be continuous or discontinuous.

In some embodiments, during one or more or each ion mobility separation scan, the centre m/z of the isolation window is substantially continuously and/or smoothly scanned. For example, the centre m/z of the isolation window may be continuously and/or smoothly scanned across (at least) the m/z range of interest. However, where the mass filter has digital control, the scanning may be approximately continuous and/or approximately smooth, as the voltages on the mass filter will in practice be changed in (small) steps.

For each strip, during a respective mobility separation scan, the centre m/z of the mass filter's isolation window may be scanned along a curve or set of curve segments in ion mobility arrival time-m/z space, such that ions within the “strip” of the two-dimensional (2D) ion mobility arrival time-m/z space are transmitted and analysed. The curve or set of curve segments may be configured to provide a one-to-one (bijective) relationship between ion mobility arrival time and m/z. Thus, in some embodiments, during one or more or each ion mobility separation scan the centre m/z of the isolation window is bijectively scanned across the m/z range of interest (i.e. using a one-to-one relationship). Equally, in some embodiments, the curve may have or the set of curve segments may each have a positive (or negative) derivative at all points along the curve or set of curve segments.

As described above, in each ion mobility separation scan, the width Δmz of the mass filter's isolation window is controlled such that ions emerging from the ion mobility separator within an ion mobility arrival time range ΔT are transmitted by the mass filter. The width Δmz of the mass filter's isolation window may be controlled such that at some, most or all times during the ion mobility separation scan, ions emerging from the ion mobility separator within an ion mobility arrival time range ΔT are transmitted by the mass filter. For example, the width Δmz of the mass filter's isolation window may be controlled such that at least when (e.g. at all times when) the isolation window's centre m/z is being scanned across the m/z range of interest, ions emerging from the ion mobility separator within an ion mobility arrival time range ΔT are transmitted by the mass filter.

In some embodiments, ΔT is held substantially constant during each ion mobility separation scan, e.g. at least during the part of the ion mobility separation scan when the isolation window's centre m/z is being scanned across the m/z range of interest. Thus, the method may comprise during one or more or each ion mobility separation scan: controlling the width Δmz of the isolation window such that when the isolation window's centre m/z is being scanned across the m/z range of interest, the ion mobility separation arrival time range ΔT is held substantially constant.

Alternatively, ΔT may be varied during an ion mobility separation scan, e.g. in a predetermined manner. Thus, the method may comprise, during one or more or each ion mobility separation scan: (ii) controlling the width Δmz of the isolation window such that when the isolation window's centre m/z is being scanned across the m/z range of interest, the ion mobility separation arrival time range ΔT is varied.

In some embodiments, ΔT is configured to be the same between different ion mobility separation scans. Thus, the method may comprise controlling the width Δmz of the isolation window such that the ion mobility separation arrival time range ΔT is the same during two or more or all ion mobility separation scans.

Alternatively, ΔT may be varied between different ion mobility separation scans, e.g. in a predetermined manner. Thus, the method may comprise controlling the width Δmz of the isolation window such that the ion mobility separation arrival time range ΔT is varied between two or more of the ion mobility separation scans.

In particular embodiments, each ion mobility separation scan has a duration T_{IMS}, and the method comprises controlling the width 4mz of the isolation window during each ion mobility separation scan according to the equation:

$$Δ mz \leq ( \frac{Δ T}{{T}_{IMS}} ) \cdot ( m / z ) \cdot {z}^{1 / 3} .$$

The ion mobility separation arrival time range ΔT may have a duration (i)≤ 0.5 ms; (ii)≤1 ms; (iii)≤2 ms; (iv)≤5 ms; (v)≤10 ms; or (vi)≤50 ms.

In some embodiments, only a single charge state band need be analysed. However, it would also be possible to analyse plural different charge state bands in the same way as is described above in respect of a single charge state.

Thus, the plurality of ion mobility separation scans may comprise a second set of K₂ ion mobility separation scans, where K₂ is an integer ≥2, and the method may comprise:
during each of the K₂ ion mobility separation scans: scanning the centre m/z of the isolation window along a respective curve or set of curve segments in ion mobility arrival time-m/z space such that ions having a second different charge state are transmitted by the mass filter.

The second set of K₂ ion mobility separation scans may be configured in a similar manner to the first set of K ion mobility separation scans, except that the second set of K₂ ion mobility separation scans may target a different charge state band.

Thus, for example, for each of the K₂ curves or sets of curve segments, most or all of the curve or set of curve segments may be separated from an adjacent curve or set of curve segments by a shift in ion mobility arrival time, where the shift in ion mobility arrival time may correspond to (i.e. may be equal to or approximately equal to) the ion mobility arrival time range ΔT. Most or all of the K₂ curves or sets of curve segments may have substantially the same shape in the ion mobility arrival time-m/z space, and the product (K₂×ΔT) may be less than the duration T of each mass analysis scan.

In these embodiments, the first charge state may be one of (i) singly charged ions; (ii) doubly charged ions; (iii) triply charged ions; (iv) quadruply charged ions; and (iv) more than quadruply charged ions. The second charge state may be one of (i) singly charged ions; (ii) doubly charged ions; (iii) triply charged ions; (iv) quadruply charged ions; and (iv) more than quadruply charged ions, where the second charge state is a different charge state to the first charge state.

Similar, a third or further charge state band can be analysed in a similar manner.

In some embodiments, the intensity of one or more or each strip may be adjusted, e.g. so as to prevent detector saturation and/or space charge effects for the particular strip and/or to improve the dynamic range of the overall analysis. For example, where it is known that a particular strip will contain ions having a relatively high abundance, the intensity of that strip may be reduced (and/or where it is known that a particular strip will contain ions having a relatively low abundance, the intensity of that strip may not be reduced or may be reduced by a lesser amount). Thus, the method may comprise, during one or more or each ion mobility separation scan: adjusting (e.g. reducing) the intensity of ions transmitted by the mass filter based on an expected intensity for those ions.

The intensity of ions may be adjusted in any suitable manner, e.g., using the techniques described in GB 2,585,472 which is incorporated herein by reference. Thus, for example, an attenuation device may be arranged downstream (or upstream) of the mass filter and may be configured to attenuate the ions, e.g., by rapid pulse-width modulation at a rate much less than ΔT. A constant attenuation factor may be used for the entirety of each strip, and/or the attenuation factor may be varied across a strip in a predetermined manner.

Although, as described above, in particular embodiments each curve or set of curve segments is shaped based on the shape of the charge state band of interest, it would also be possible for the shape of part or all of a curve or set of curve segments to be determined based on one or more other factors.

For example, in some embodiments, a targeted analysis approach may be taken. In these embodiments, the curve or set of curve segments in respect of a strip may be configured to include (i.e. to pass through) ions of one or more isotopically labelled internal standards in the sample. For example, a curve or set of curve segments may be configured to include (to pass through) ions of multiple isotopically labelled internal standards of interest in the sample. Then, during an ion mobility separation scan, when an internal standard of interest is detected, a targeted scan for the corresponding target analyte may be activated.

Thus, the method may comprise:
adding one or more internal standard(s) of one or more target analytes to a sample;
ionising the sample and internal standard(s) to produce ions;
during a first ion mobility separation scan: (i) scanning a centre mass to charge ratio (m/z) of the isolation window such that ions of the internal standard(s) are transmitted by the mass filter; and
determining whether ions of an internal standard are detected in a mass analysis scan;
wherein, when it is determined that ions of an internal standard(s) are detected a mass analysis scan, the method further comprises performing one or more target scans each having a target isolation window including an m/z representative of the target analyte.

For example, a target scan for the target analyte may be performed during a second ion mobility separation scan, which may be the ion mobility separation scan that immediately follows the first ion mobility separation scan. In some embodiments, the curve or set of curve segments for the second ion mobility separation scan may be locally distorted to include (to pass through) the target analyte.

In some embodiments, the curve or set of curve segments in respect of a strip may be configured to include (i.e. to pass through) different charge states of the same molecule. Thus, the method may comprise: during an ion mobility separation scan: (i) scanning a centre mass to charge ratio (m/z) of the isolation window such that ions of the same analyte having plural different charge states are transmitted by the mass filter. Multiple such ion mobility separation scans may be performed, where each ion mobility separation scan is directed to a different analyte.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

A further aspect provides an analytical instrument, such as a mass spectrometer, comprising:
an ion mobility separator, wherein the ion mobility separator is configured to perform ion mobility separation scans, wherein in each ion mobility separation scan the ion mobility separator receives ions and separates them according to their ion mobility;
a mass filter arranged downstream of the ion mobility separator; and
a mass analyser arranged downstream of the mass filter, wherein the mass analyser is configured to perform mass analysis scans, wherein in each mass analysis scan the mass analyser receives ions and mass analyses them; and
a control system configured to:
cause the instrument to perform a plurality of ion mobility separation scans;
during each ion mobility separation scan, cause the mass filter to: (i) scan a centre mass to charge ratio (m/z) of the isolation window, and (ii) control a width Δmz of the isolation window such that during the ion mobility separation scan, ions emerging from the ion mobility separator within an ion mobility arrival time range ΔT are transmitted by the mass filter; and
cause the mass analyser to perform one or more mass analysis scan(s) during each ion mobility separation scan, wherein each mass analysis scan has a duration T, and wherein ΔT<T.

These aspects and embodiments can be, and in embodiments are, combined with any one or more or each of the aspects, embodiments and/or optional features described herein.

### DESCRIPTION OF THE DRAWINGS

Various embodiments will now be described in more detail with reference to the accompanying Figures, in which:

FIG. 1 illustrates a known method;

FIG. 2 illustrates schematically a mass spectrometer that can be operated in accordance with embodiments;

FIG. 3 illustrates a method in accordance with embodiments; and

FIG. 4 illustrates a method in accordance with embodiments.

### DETAILED DESCRIPTION

Embodiments improve resolution of IMS determination with “slow” mass analysers and reduce the time of analysis required to create a 2D mobility-m/z diagram.

This is achieved by the realisation that only a small part of the 2D mobility-m/z space is actually occupied by ions of interest (usually <10-20%) due to strong correlation between ion mobility and m/z. In addition, for many analytes of interest, especially in metabolomics, just one charge state, usually singly or doubly charged ions, needs to be analysed. This means that ions usually occupy a relatively narrow band with an ion mobility arrival time width Tb (m/z), where in some cases Th<T.

Embodiments provide an optimised approach similar to the linked scan approach, wherein discrete changes in the quadrupole's centre m/z are minimised by matching mass selection with the required mobility time resolution ΔT.

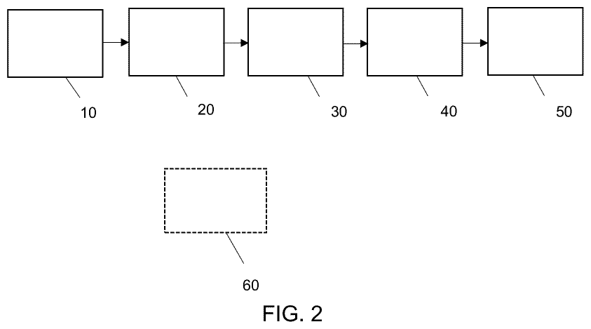

FIG. 2 illustrates schematically an analytical instrument, such as a mass spectrometer (MS), that may be operated in accordance with embodiments. As shown in FIG. 2, the instrument includes an ion source 10, an ion mobility (IM) separator 20 (such as a high-resolution ion mobility separator (hrIMS)), a mass filter 30, a fragmentation device 40, and a mass analyser 50.

The ion source 10 is configured to generate ions from a sample. The ion source 10 can be any suitable continuous or pulsed ion source, such as an electrospray ionisation (ESI) ion source, a MALDI ion source, and atmospheric pressure ionisation (API) ion source, a plasma ion source, an electron ionisation ion source, a chemical ionisation ion source, and so on. More than one ion source may be provided and used. The ions may be any suitable type of ions to be analysed, e.g. small and large organic molecules, biomolecules, DNA, RNA, proteins, peptides, fragments thereof and the like.

The ion source 10 may be coupled to a separation device such as a liquid chromatography separation device or a capillary electrophoresis separation device (not shown), such that the sample which is ionised in the ion source 10 comes from the separation device.

The ion mobility separator 20 is arranged downstream of the ion source 10 and is configured to receive ions from the ion source 10. The ion mobility separator 20 is configured to separate received ions according to their ion mobility. The ion mobility separator 20 may comprise any suitable type of ion mobility separator. For example, an electric field, such as a DC voltage gradient and/or a travelling DC voltage wave, may be arranged to urge ions along the length of the separator and through a gas, so that the ions are separated according to their ion mobility. The ions may optionally be urged against a counter flow of gas or perpendicularly to it. Alternatively, a gas flow may be arranged to urge ions along the length of the separator, while an electric field, such as a DC voltage gradient and/or a travelling DC voltage wave, may be arranged to oppose the gas flow so that the ions are separated according to their ion mobility. The ion mobility separator 20 may be a linear separator with a straight or folded path or a cyclic (closed-loop) separator.

The mass filter 30 is arranged downstream of the ion mobility separator 20 and is configured to receive ions from the ion source 10 (via the ion mobility separator 20). The mass filter 30 is configured to filter the received ions according to their mass to charge ratio (m/z). The mass filter 30 may be configured such that received ions having m/z within an m/z isolation window (or “transmission window”) of the mass filter are onwardly transmitted by the mass filter, while received ions having m/z outside the m/z isolation window are attenuated by the mass filter, e.g. are not onwardly transmitted by the mass filter. The width and/or the centre m/z of the isolation window may be controllable (variable), e.g. by suitable control of RF and/or DC voltage(s) applied to the mass filter 30. Thus, for example, the mass filter 30 may be operable in a transmission mode of operation, whereby most or all ions within a relatively wide m/z window are onwardly transmitted by the mass filter 30, and a filtering mode of operation, whereby only ions within a relatively narrow m/z window (centred at a desired m/z) are onwardly transmitted by the mass filter 30. The mass filter 30 can be any suitable type of mass filter, such as a quadrupole mass filter.

The fragmentation device 40 is arranged downstream of the mass filter 30 and is configured to receive most or all ions transmitted by the mass filter 30. The fragmentation device 40 may be configured to selectively fragment some or all of the received ions, i.e. so as to produce fragment ions. The fragmentation device 40 may be operable in a fragmentation mode of operation, whereby most or all received ions are fragmented so as to produce fragment ions (which may then be onwardly transmitted from the fragmentation device 40), and a non-fragmentation mode of operation, whereby most or all received ions are onwardly transmitted without being (deliberately) fragmented. It would also be possible for a non-fragmentation mode of operation to be implemented by causing ions to bypass the fragmentation device 40. The fragmentation device 40 may also be operable in one or more intermediate modes of operation, e.g. whereby the degree of fragmentation is controllable (variable).

The fragmentation device 40 can be any suitable type of fragmentation device, such as for example a collision induced dissociation (CID) fragmentation device, an electron induced dissociation (EID) fragmentation device, a photodissociation fragmentation device, and so on. Numerous other types of fragmentation are possible.

The mass analyser 50 is arranged downstream of the ion mobility separator 20 and is configured to receive ions from the ion source 10 (via the ion mobility separator 20 and mass filter 30, and optionally via the fragmentation device 40). The mass analyser 50 is configured to analyse the received ions so as to determine their mass to charge ratio and/or mass, i.e. to produce a mass spectrum of the ions. The mass analyser 50 may be an ion trap mass analyser, such as an electrostatic orbital trap mass analyser, and more specifically an Orbitrap™ FT mass analyser.

Thus, the mass analyser 50 may comprise an inner electrode elongated along the orbital trap axis and a split pair of outer electrodes which surround the inner electrode and define therebetween a trapping volume in which ions are trapped and oscillate by orbiting around the inner electrode to which is applied a trapping voltage whilst oscillating back and forth along the axis of the trap. The pair of outer electrodes function as detection electrodes to detect an image current induced by the oscillation of the ions in the trapping volume and thereby provide a detected signal. The outer electrodes typically function as a differential pair of detection electrodes and are coupled to respective inputs of a differential amplifier, which in turn forms part of a digital data acquisition system to receive the detected signal. The detected signal can be processed using Fourier transformation to obtain a mass spectrum of ions within the trap.

Alternatively, the mass analyser 50 can be a time-of-flight (ToF) mass analyser such as a multi-reflection time-of-flight (mrToF) mass analyser.

It should be noted that FIG. 2 is merely schematic, and that the instrument can, and in embodiments does, include any number of one or more additional components.

For example, the instrument may include one or more ion transfer or trapping stage(s), e.g. arranged between the various illustrated devices. The one or more ion transfer stage(s) may include, e.g., an atmospheric pressure interface and/or one or more ion guides, lenses and/or other ion optical devices configured such that ions can be transferred between the various illustrated devices. The ion transfer stage(s) may include any suitable number and configuration of ion optical devices, for example optionally including one or more RF and/or multipole ion guides, one or more ion guides for cooling ions, one or more mass selective ion guides, and so on.

As also shown in FIG. 2, the instrument is under the control of a control unit 60, such as an appropriately programmed computer, which controls the operation of various components of the instrument. The control unit 60 may also receive and process data from various components including the analyser 50. The control unit 60 is configured, amongst other things, to determine the settings for the ion mobility separator 20, mass filter 30, fragmentation device 40, and the mass analyser 50 for analytical scans.

For example, the control system 60 may cause the instrument to perform one or more MS1 scans, wherein in each MS1 scan the mass filter 30 is operated in its transmission mode or in its filtering mode and ions are not (intentionally) fragmented, so that a broad m/z range of ions produced by the ion source 10 is mass analysed by the mass analyser 50.

The control system 60 may also cause the instrument to perform one or more MS2 scans, wherein in each MS2 scan the mass filter 30 is operated in its filtering mode and ions are fragmented in the fragmentation device 40, so that a narrow m/z range of ions produced by the ion source 10 is selected and fragmented, and the resulting fragment ions are mass analysed by the mass analyser 50.

Thus, in embodiments, ions are formed by an ion source 10 and are supplied to the hrIMS device 20, which may have a trapping and release regions to provide 100% duty cycle of collecting ions from the source 10. There may be an ion gate and/or an additional mass filter prior to the hrIMS device 20 to control the total number of ions in it. As ions are eluted from the hrIMS device 20, they are filtered by their m/z using a quadrupole mass filter 30, and after optional fragmentation in the collision cell 40, they are detected by a mass analyser 50. The mass analyser 50 may be an Orbitrap™ mass analyser, a FT ICR mass analyser, or a ToF or mrToF mass analyser of any type. The mass analyser may be integrated with an ion storage device, to collect and buffer all ions leaving the quadrupole mass filter 30.

In operation, for each scan of the hrIMS device 20, the quadrupole 30 follows a particular smooth line or curve T_{IMS} (m/z) on the 2D mobility-m/z diagram in such a way that at every point of this curve, the width Δmz of the quadrupole mass filter's isolation window is defined by a desired mobility time resolution ΔT as:

$$Δ mz \leq Δ T / {( \frac{{dT}_{IMS}}{dx} )}_{x = m / z} \qquad ( 1 )$$

Using the hard-sphere approximation, the ion mobility u relates to mass m and the charge z of an ion as: μ˜z/m^{2/3}, and T_{IMS}˜1/u, hence this equation can be re-written as:

$$Δ mz \leq ( \frac{Δ T}{{T}_{IMS}} ) \cdot ( m / z ) \cdot {z}^{1 / 3} \qquad ( 2 )$$

For a band of mobilities of average spread in mobility time Tb, it would take K=TbIΔT steps to create the 2D mobility-m/z diagram for the compound class of interest (e.g. lipids, glycans, nucleotides or peptides of a certain charge state, etc.). As Tb can be established during method development or calibration, it can be selected to be substantially smaller than the analysis duration T, hence K<L and less time is needed to cover the region of interest with high mobility resolution.

ΔT and hence Δmz may also or instead be made dependent on m/z.

The curve T_{IMS} (m/z) may have variations of shape as soon long as its derivative remains entirely positive (or entirely negative) (so that IMS resolution is encoded in m/z), and its smoothness ensures that the quadrupole filtering is able to follow it accurately without smearing, ion losses or gaps in mobility time. The quadrupole mass filter 30 may be able to scan with the a speed >1000 Th/second, or >10,000 Th/second.

As described above, a set of adjacent curves/stripes may be acquired in this manner. When the entire set of adjacent curves/stripes is acquired to cover the region of interest, all known methods of interpolation and data extraction may be used. For example, if isotope distributions of particular analytes spread over 2-3 adjacent stripes, this may be used to determine ion mobility with higher accuracy than ΔT, potentially achieving a resolving power >500 on mobility.

It will be understood that embodiments provide the use of linked hrIMS-quadrupole scan with a narrow and smoothly changing window of mass selection to improve performance of the system. Embodiments increase the speed of acquisition of a 2D mobility-m/z landscapes when a slow mass analyser is used for detection, and especially when only a particular class of compounds is analysed.

Although various particular embodiments have been described above, various alternative embodiments are possible.

For example, non-standard mass filters (e.g. a mass filter with several notch filters within its mass window of transmission) may be used to acquire not one, but two or three or more strips in parallel, thus further improving the speed of the acquisition.

The method may be used both with data-dependent and data-independent acquisitions (DDA and DIA, respectively).

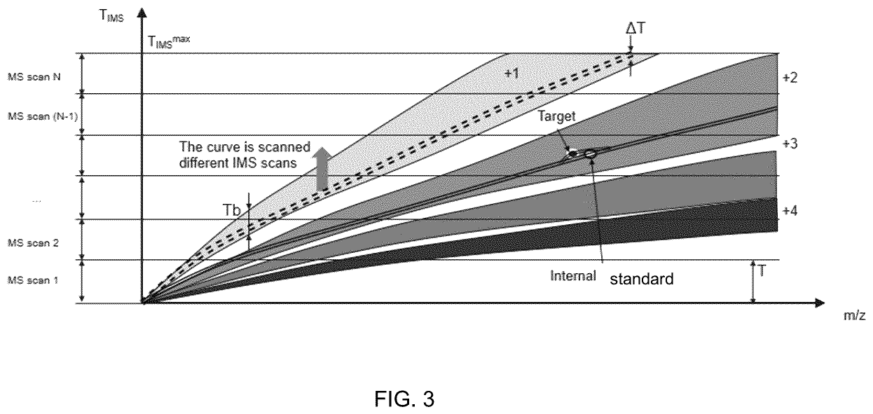

The method is particularly suitable for a targeted analysis, wherein the curve is shaped during method development in such a way that it goes through all isotopically labelled internal standards in the mixture. Then, the analysis is run along this curve. As soon as one or more of internal standards are detected, targeted analysis of corresponding analytes may be activated. This may be also done by locally distorting the curve to go over the targeted compound (FIG. 3).

The method may be also used with pulsed ion sources such as MALDI, in order to focus on specific low-abundance components. It is especially effective for cases when T>T_{IMS}^{max}, i.e. fast IMS, but works well also with structures for lossless ion manipulations (SLIM), trapped ion IMS and cyclic IMS where T_{IMS}^{max} may reach 100s of milliseconds or even seconds.

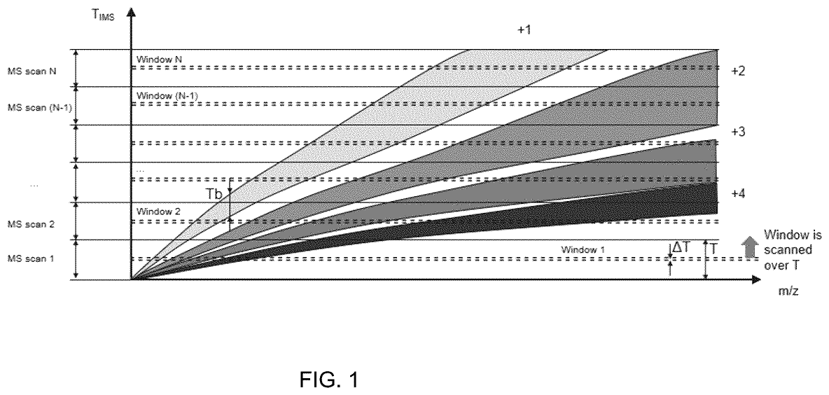

There may be benefit in combining method of FIG. 1 with the method of FIG. 3. For example, the prior art method could be run with lower resolution (bigger ΔT) to give a crude but panoramic 2D diagram and then method of FIG. 3 could be used to get higher resolution mobility information for particular regions of interest depending on a particular analytical problem (e.g. for separation of isomers, etc.).

The method may involve scanning the centre m/z of the isolation window across a continuous m/z range (as is shown in FIG. 3), but could instead involve scanning the centre m/z of the isolation window across a set of distinct and separation m/z sub-ranges. This may allow, for example, high-dynamic range scans, targeted multiplexed analyses, selection of different charge states of the same multiply charged analyte, and so on.

In some embodiments, the intensity of the transmitted window may be adjusted based on its (a priori measured) intensity. The intensity of ions may be adjusted in any suitable manner, e.g. using the techniques described in GB 2,585,472, i.e. rapid pulse-width modulation at a rate much less than ΔT.

Although, as described above, in various embodiments each curve is shaped based on the shape of the charge state band of interest, it would also be possible for the shape of part or all of a curve to be determined based on one or more other factors.

For example, in some embodiments, the method may comprise isolating multiple charges together. This is especially effective where T_{IMS} is comparable to or less than T. In this case, different charge states z of the same molecule (e.g. protein) may be isolated and analysed together as they appear at different m/z and different mobility arrival times.

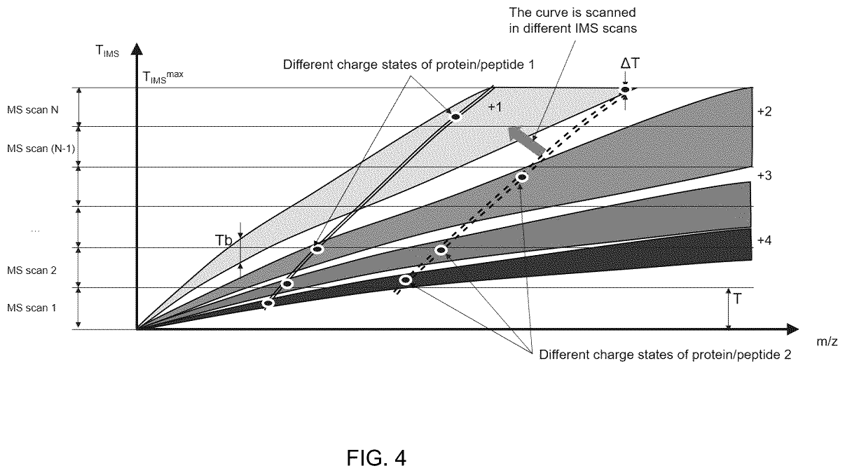

FIG. 4 illustrated an example of selecting multiple charge states of the same analyte by a linked quadrupole/IMS scan according to this method. In FIG. 4, the double dashed lines and the solid lines are shown for two different analytes. Analytes of interest may be gated for selection or acquired with other analytes.

In these embodiments, for each analyte, (m/z)*z=m is constant, but the ion mobility arrival times depend on the collisional cross-sections of the charge states. This may be known a priori or from a calibration. Thus, as is shown in FIG. 4, during each ion mobility separation scan, the centre m/z of the isolation window may be scanned across multiple different charge state bands, such that ions of the same analyte (e.g. the same protein) having plural different charge states are transmitted by the mass filter. Multiple such ion mobility separation scans may be performed, where each ion mobility separation scan is directed to a different analyte (e.g. a different protein).

Although the present invention has been described with reference to various embodiments, it will be understood that various changes may be made without departing from the scope of the invention as set out in the accompanying claims.

1. A method of operating an analytical instrument that comprises an ion mobility separator, a mass filter arranged downstream of the ion mobility separator, and a mass analyser arranged downstream of the mass filter, the method comprising:
the ion mobility separator performing a plurality of ion mobility separation scans, wherein in each ion mobility separation scan the ion mobility separator receives ions and separates them according to their ion mobility;
the mass filter filtering separated ions using an isolation window, and during each ion mobility separation scan: (i) scanning a centre mass to charge ratio (m/z) of the isolation window, and (ii) controlling a width Δmz of the isolation window such that during the ion mobility separation scan, ions emerging from the ion mobility separator within an ion mobility arrival time range ΔT are transmitted by the mass filter; and
the mass analyser performing one or more mass analysis scan(s) during each ion mobility separation scan, wherein in each mass analysis scan the mass analyser receives and analyses ions transmitted by the mass filter or ions derived from the ions transmitted by the mass filter, wherein each mass analysis scan has a duration T, and wherein ΔT<T.

2. The method of claim 1, wherein the plurality of ion mobility separation scans comprises at least a first ion mobility separation scan and a second ion mobility separation scan, and wherein the method comprises:
during the first ion mobility separation scan: scanning the centre mass to charge ratio of the isolation window along a first curve or first set of curve segments in ion mobility arrival time-m/z space such that ions having a first charge state are transmitted by the mass filter; and
during the second ion mobility separation scan: scanning the centre mass to charge ratio of the isolation window along a second different curve or second set of curve segments in the ion mobility arrival time-m/z space such that ions having the same first charge state are transmitted by the mass filter.

3. The method of claim 2, wherein most or all of the second curve or second set of curve segments is separated from the first curve or first set of curve segments by a shift in ion mobility arrival time.

4. The method of claim 3, wherein the shift in ion mobility arrival time corresponds to the ion mobility arrival time range ΔT.

5. The method of claim 2, wherein the second curve or second set of curve segments has substantially the same shape in the ion mobility arrival time-m/z space as the first curve or first set of curve segments.

6. The method of claim 1, wherein the plurality of ion mobility separation scans comprises a first set of K ion mobility separation scans, and wherein the method comprises:
during each of the K ion mobility separation scans: scanning the centre mass to charge ratio of the isolation window along a respective curve or set of curve segments in ion mobility arrival time-m/z space such that ions having a first charge state are transmitted by the mass filter;
wherein for each of the K respective curves or sets of curve segments, most or all of the curve or set of curve segments is separated from an adjacent curve or set of curve segments by a shift in ion mobility arrival time.

7. The method of claim 6, wherein:
the shift in ion mobility arrival time corresponds to the ion mobility arrival time range ΔT; and/or
most or all of the K curves or sets of curve segments have substantially the same shape in the ion mobility arrival time-m/z space.

8. The method of claim 6, wherein a product (K×ΔT) is less than the duration T of each mass analysis scan.

9. The method of claim 6, wherein the plurality of ion mobility separation scans comprises a second set of K₂ ion mobility separation scans, and wherein the method comprises:
during each of the K₂ ion mobility separation scans: scanning the centre mass to charge ratio of the isolation window along a respective curve or set of curve segments in ion mobility arrival time-m/z space such that ions having a second different charge state are transmitted by the mass filter;
wherein for each of the K₂ curves or sets of curve segments, most or all of the curve or set of curve segments is separated from an adjacent curve or set of curve segments by a shift in ion mobility arrival time.

10. The method of claim 9, wherein:
the first charge state is one of (i) singly charged ions; (ii) doubly charged ions; (iii) triply charged ions; (iv) quadruply charged ions; and (iv) more than quadruply charged ions; and/or
the second charge state is one of (i) singly charged ions; (ii) doubly charged ions; (iii) triply charged ions; (iv) quadruply charged ions; and (iv) more than quadruply charged ions, and the second charge state is a different charge state to the first charge state.

11. The method of claim 1, wherein the plurality of ion mobility separation scans comprises at least a first ion mobility separation scan, and wherein the method further comprises:
adding one or more internal standard(s) of one or more target analytes to a sample;
ionising the sample and internal standard(s) to produce ions; and
during the first ion mobility separation scan: (i) scanning a centre mass to charge ratio (m/z) of the isolation window such that ions of the internal standard(s) are transmitted by the mass filter, and (ii) determining whether ions of an internal standard are detected in a mass analysis scan;
wherein, when it is determined that ions of an internal standard are detected a mass analysis scan, the method further comprises performing one or more target scans each having a target isolation window including an m/z representative of the target analyte.

12. The method of claim 1, further comprising:
during an ion mobility separation scan of the plurality of ion mobility separation scans: (i) scanning a centre mass to charge ratio (m/z) of the isolation window such that ions of the same analyte having plural different charge states are transmitted by the mass filter.

13. The method of claim 1, comprising:
during one or more or each ion mobility separation scan: (i) scanning the centre m/z of the isolation window across a m/z range of interest;
wherein the m/z range of interest is continuous; or
wherein the m/z range of interest comprises a set of distinct and separated m/z sub-ranges.

14. The method of claim 13, comprising:
during one or more or each ion mobility separation scan: (i) substantially smoothly and/or substantially continuously and/or bijectively scanning the centre m/z of the isolation window across the m/z range of interest.

15. The method of claim 13, comprising:
during one or more or each ion mobility separation scan: (ii) controlling the width Δmz of the isolation window such that when the isolation window centre m/z is being scanned across the m/z range of interest, ions emerging from the ion mobility separator within an ion mobility arrival time range ΔT are transmitted by the mass filter.

16. The method of claim 13, comprising:
during one or more or each ion mobility separation scan: (ii) controlling the width Δmz of the isolation window such that when the isolation window centre m/z is being scanned across the m/z range of interest, an ion mobility separation arrival time range ΔT is held substantially constant; and/or
during one or more or each ion mobility separation scan: (ii) controlling the width Δmz of the isolation window such that when the isolation window's centre m/z is being scanned across the m/z range of interest, the ion mobility separation arrival time range ΔT is varied; and/or
controlling the width Δmz of the isolation window such that the ion mobility separation arrival time range ΔT is the same during two or more or all of the plurality of ion mobility separation scans; and/or
controlling the width Δmz of the isolation window such that the ion mobility separation arrival time range ΔT is varied between two or more of the plurality of ion mobility separation scans.

17. The method of claim 1, wherein each ion mobility separation scan has a duration T_{IMS}, and wherein the method comprises controlling the width Δmz of the isolation window during each ion mobility separation scan according to:
$$Δ mz \leq ( \frac{Δ T}{{T}_{IMS}} ) \cdot ( m / z ) \cdot {z}^{1 / 3} .$$

18. The method of claim 1, further comprising during an ion mobility separation scan of the plurality of ion mobility separation scans: adjusting an intensity of ions transmitted by the mass filter based on an expected intensity for the ions.

19. The method of claim 1, wherein:
the duration T is (i)≥1 ms; (ii)≥2 ms; (iii)≥5 ms; (iv)≥10 ms; (v)≥50 ms; or (vi)≥100 ms; and/or
the ion mobility arrival time range ΔT is (i)≤0.5 ms; (ii)≤1 ms; (iii)≤2 ms;
(iv)≤5 ms; (v)≤10 ms; or (vi)≤50 ms.

20. The method of claim 1, wherein the mass analyser is a Fourier Transform (FT) mass analyser or a multi-reflection time-of-flight (mrTOF) mass analyser.

21. A control system for an analytical instrument, the control system configured to cause the analytical instrument to perform the method of claim 1.

22. An analytical instrument, comprising the control system of claim 21.

23. A mass spectrometer, comprising the control system of claim 21.
